(19) United States
(12) Patent Application Publication
(10) Pub. No.: US 2007/0055893 A1
(43) Pub. Date: Mar. 8, 2007

(54) Method and system for providing data field encryption and storage

(75) Inventor: Thomas Lance Dodd, Colorado Springs, CO (US)

Correspondence Address: VERIZON;PATENT MANAGEMENT GROUP, 1515 N. COURTHOUSE ROAD, SUITE 500, ARLINGTON, VA, 22201-2909, US

(73) Assignee: MCI, Inc., Ashburn, VA (US)

(21) Appl. No.: 11/210,513

(22) Filed: Aug. 24, 2005

(51) Int. Cl. G06F 12/14

(52) U.S. Cl. 713/193

(57) ABSTRACT

A central encryption and storage manager is provided for securely storing sensitive data values for requestors such as clients. A requester sends an actual data value to the central encryption and storage manager via a secure network connection for storage. After authenticating the requester, the central encryption and storage manager obtains a replacement value associated with the actual data value and encrypts the actual data value. The replacement value and the encrypted actual data value are then stored by the central encryption and storage manager, and the replacement value is transmitted back to the requestor for storage by the requestor. When the requestor needs an actual data value, the requester retrieves the replacement value associated with the actual data value and securely transmits the replacement value to the central encryption and storage manager. After authenticating the requestor, the central encryption and storage manager retrieves the encrypted actual data value using the replacement value, decrypts the actual value, and securely transmits the actual data value back to the requestor.

### FIELD OF THE INVENTION

The present invention relates to data storage and more particularly to encryption and storage of sensitive data.

### BACKGROUND OF THE INVENTION

With the onset of public use of the Internet and the World Wide Web, secure handling of sensitive data has become a very important issue. Hackers have become very sophisticated in their techniques for accessing sensitive data stores. It has become more and more common for these hackers to steal and use for illegal purposes, such data stores, which can include private information such as social security numbers, driver's license numbers, calling card numbers, bank account numbers, and credit card numbers. Legislatures have responded to identity theft by enacting laws requiring businesses that store sensitive data to perform certain steps to ensure a particular level of integrity of the data. For example, a law may require a certain level of encryption or firewall protection, or the law may require that if data is compromised, a keeper of the data store so compromised may be required to inform all owners of the compromised data of the breach so that they may take appropriate steps such as informing credit bureaus to issue a fraud alert for their credit records, as well as monitoring their credit records for fraudulent activity.

A common method of storage of sensitive data involves encrypting the data and storing it in a database. Thus, data regarding a particular entity, such as a customer, is stored in common facilities. To access the data, a hacker need only figure out how to break in to the facility and how to decrypt the data, and the hacker would then have enough information to be able to make fraudulent use of the data. For example, if a hacker broke into a telecommunications client's database and managed to obtain a customer's identity and card number, the hacker might be able to fraudulently make thousands of dollars of calls using the information.

Therefore, there is a need for more secure storage of sensitive data.

### SUMMARY OF THE INVENTION

These and other needs are addressed by methods and systems consistent with the present invention in which a central encryption and storage manager is provided for encrypting and storing sensitive data of requesters such as clients and generating replacement values associated with sensitive data values such that the requesters need only store and transmit the replacement value associated with a sensitive data value to receive the actual data value from the central manager for use by the requester. Thus, the requestor has no need to store actual sensitive data values in the requestor's storage media, or values that are algorithmically derivable from the actual sensitive data, thereby eliminating the hazard of compromising the data by potential hackers of the requestor's storage media.

In accordance with an embodiment of the present invention, a method for securely storing data is provided. The method comprises receiving an actual data value from a requestor, obtaining a replacement value having an association with the actual data value, encrypting the actual data value, storing an indicator indicating the association between the encrypted data value and the replacement value, and transmitting the replacement value to the requester.

In accordance with another embodiment of the present invention, a method for securely managing data is provided. The method comprises transmitting an actual data value by a requestor to a hardened facility for storage at the hardened facility, receiving a replacement value associated with the actual data value, and storing the replacement value by the requestor.

In accordance with a further embodiment of the present invention, a method is provided which comprises transmitting a first actual data value corresponding to a first sensitive data field value and a second actual data value corresponding to a second sensitive data field value included in a plurality of records of a requestor from the requestor to a hardened facility for storage at the hardened facility, receiving a first replacement value associated with the first actual data value and a second replacement value associated with the second actual data value, and storing the first replacement value in a first storage device and the second replacement value in a second storage device by the requester.

In accordance with a further embodiment of the present invention, a central encryption system for securely managing data is provided. The system comprises a central encryption device configured to receive an actual data value from a requestor, to obtain a replacement value associated with the actual data value, to encrypt the actual data value, to store an indicator of an association between the replacement value and the encrypted data value, and to transmit the replacement value to the requester. The system also comprises a storage device for storing the indicator of the association between the replacement value and the encrypted data value.

In accordance with yet another embodiment of the present invention, a central encryption system for securely managing data is provided. The system comprises a central encryption device configured to receive a replacement value associated with an actual data value from a requestor, to retrieve an encrypted data value corresponding to the actual data value based on the replacement value, to decrypt the encrypted data value to obtain the actual data value, and to transmit the actual data value to the requestor. The system further comprises a storage device for storing the replacement value and the encrypted data value.

In accordance with a further embodiment of the present invention, a central encryption and storage system is provided. The system comprises means for receiving an actual data value from a requester, obtaining a replacement value associated with the actual data value, encrypting the actual data value, storing the encrypted data value, and transmitting the replacement value to the requestor.

In accordance with a further embodiment of the present invention, a secure system is provided. The system comprises a first process configured to transmit an actual data value from the secure system to a central manager for storage by the central manager and to receive a replacement value associated with the actual data value, and a storage device configured to store the replacement value.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 depicts a networked system with an exemplary central encryption service for providing replacement values and storing actual values according to an exemplary embodiment of the present invention;

FIG. 2 depicts a networked system with an exemplary central encryption service for generating replacement values and storing encrypted actual data values for an exemplary requestor such as a client in accordance with an embodiment of the present invention;

FIG. 3a is a flowchart depicting exemplary steps that may be performed by an exemplary client requesting a replacement value from an exemplary central encryption service in accordance with an embodiment of the present invention;

FIG. 3b is a flowchart depicting exemplary steps that may be performed by an exemplary central encryption service providing a replacement value to an exemplary client in accordance with an exemplary embodiment of the present invention;

FIG. 4 depicts a networked system with an exemplary central encryption service for retrieving stored actual values according to an exemplary embodiment of the present invention;

FIG. 5a is a flowchart depicting exemplary steps that may be performed by an exemplary client requesting an actual value from an exemplary central encryption service in accordance with an exemplary embodiment of the present invention;

FIG. 5b is a flowchart depicting exemplary steps that may be performed by an exemplary central encryption service providing an actual value to an exemplary client in accordance with an exemplary embodiment of the present invention;

FIG. 6 depicts an exemplary system flow diagram illustrating data flow between an exemplary client and an exemplary central encryption service in accordance with an exemplary embodiment of the present invention;

FIG. 7 depicts an exemplary system flow diagram illustrating data flow between an exemplary client and an exemplary server service providing secure communication in accordance with an exemplary embodiment of the present invention;

FIG. 8 depicts an exemplary customer record for an exemplary client system and exemplary storage for the client system and an exemplary central encryption service in accordance with an exemplary embodiment of the present invention; and

FIG. 9 depicts a computer system that can be used to implement an embodiment of the present invention.

### DESCRIPTION OF THE PREFERRED EMBODIMENT

A system, method, and software for a central encryption and storage manager are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

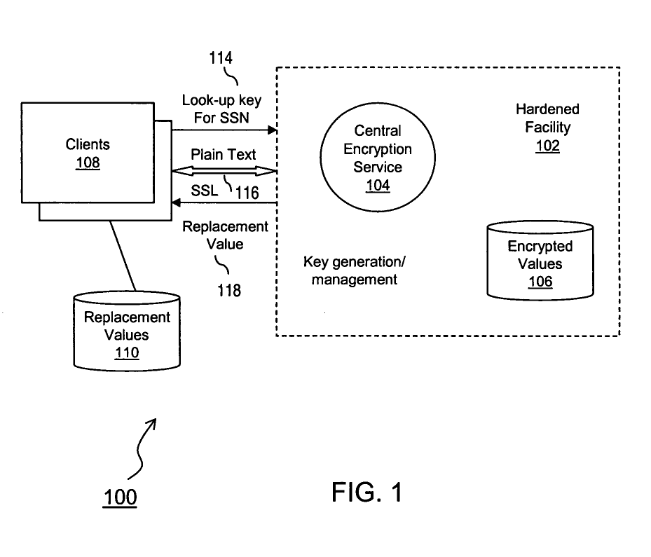

FIG. 1 depicts a networked system 100 with an exemplary central encryption service 104 for providing replacement values and storing actual values according to an exemplary embodiment of the present invention. The depiction shown in FIG. 1 illustrates clients 108 or requestors requesting a replacement value 118 from the central encryption service 104 for an actual, sensitive data value, for example, by sending a look-up key value for a social security number (SSN) 114. The clients 108 may generally be any type of application, process, system, etc. that may need to store or process any type of sensitive data. Generally, the clients 108, or requesters, send a request 114 via a secure connection (e.g., Secure Sockets Layer (SSL)) 116 over a network to a separate hardened facility 102, which is responsible for generating and managing the replacement values and look-up key values, which may be used as an index for storing and retrieving the actual values. After verification of the requester, the central encryption service 104 produces a replacement value 118 for the received actual data value and encrypts the received actual data value. The replacement value 118 may be generated as a data value having the same data attributes as the received actual data value; for example, a nine-digit social security number may be assigned a nine-digit numeric replacement value which “looks like” a social security number, but is a meaningless value to potential hackers. For example, if an actual value of a social security number is “978990123” then a replacement value of “943001234” may be obtained as a replacement value to be used as the look-up key value for the actual, sensitive value “978990123”. The replacement value is merely used as a placeholder value for the client 108 or requestor to store and use to request the actual values by using the replacement value as a look-up key value. The clients 108 are generally separated from the hardened facility 102 such that the clients 108 may only retrieve an actual sensitive value by properly requesting the actual sensitive data value from the hardened facility 102 by providing the replacement value corresponding to the actual sensitive data value.

The replacement value 118 and the encrypted actual data value are then stored in an encrypted values storage 106. The two values may be stored as a replacement value 118 and encrypted value data pair that may be looked up by either of the two values. The replacement value 118 is then transmitted back to the clients 108, which may store the replacement value in a replacement values storage 110. The clients 108 may request replacement values for any number of different sensitive data fields such as: social security numbers, calling card numbers, bank account numbers, credit card numbers, driver license numbers, employee numbers, student account numbers, etc. One skilled in the art would recognize that sensitive data fields may include any type of data, such as numeric, alphabetic, special characters, etc. Each different sensitive data field, or portion thereof, for a particular customer may be assigned a different replacement value, thus adding complexity to the task of a hacker trying to compromise a customer's sensitive information. The encrypted actual data values are stored separately in the central hardened facility 102 in separate logical encrypted values storage 106, and thus even if a hacker accesses the hardened facility's media 106, they would only get meaningless data. One skilled in the art would recognize that these values may be stored in other ways than those described herein without deviating from the spirit or scope of the present invention. For example, instead of actually storing the replacement value 118 in the encrypted values storage 106, the replacement value may instead be used as an index, or look-up key value to store and retrieve the corresponding data value. Another indicator of an association, or correspondence between the actual data value and the replacement value, for example, may be stored in lieu of storing the pairs of values as well.

When the clients 108 need the actual data, for example, for billing, statistics, or other types of reporting, the clients 108 simply access the replacement value 118 from the replacement values storage 110 located at the clients' facilities and send the replacement value 118 with a request to the hardened facility 102, where the requestor is authenticated. The replacement value 118 is then used to look up the actual data value in the encrypted values storage 106, the retrieved encrypted value is decrypted, and then sent back via a secure connection to the requestor. The clients 108, thus advantageously, have no need to store actual sensitive data values at the clients' facilities. A hacker accessing the replacement values storage 110 would only retrieve data values that are meaningless to all but the hardened facility 102, which is a centralized repository physically and logically separated from the clients 108.

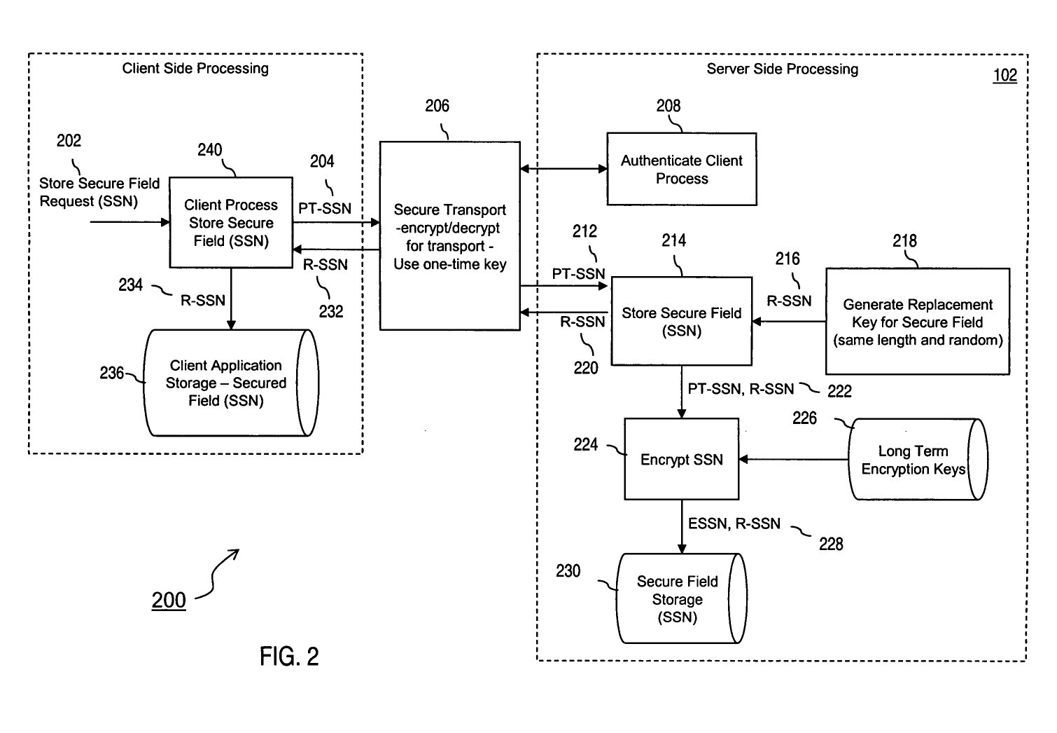

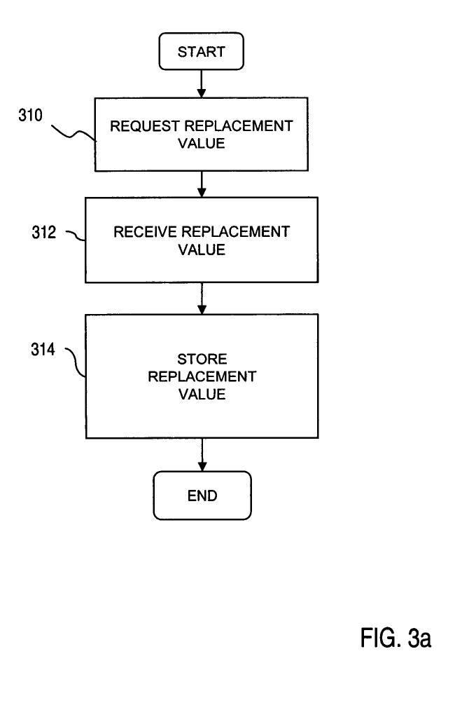

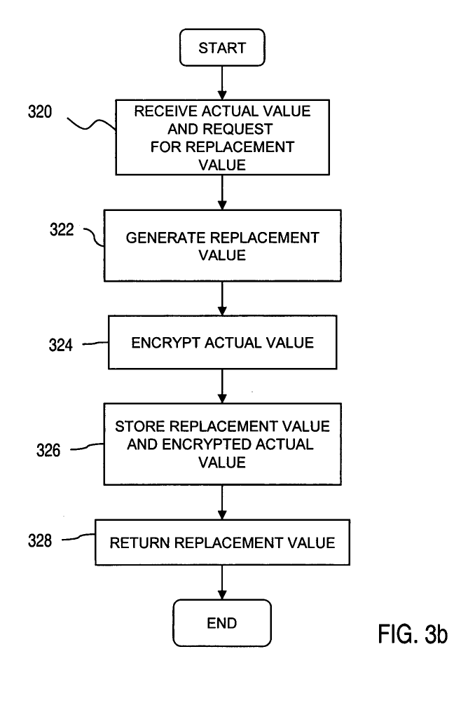

FIG. 2 depicts a networked system 200 supporting an exemplary central encryption service 104 for generating replacement values 118 and storing encrypted actual data values for an exemplary client 108. FIG. 3a is a flowchart depicting exemplary steps that may be performed by the exemplary client 108 requesting a replacement value from an exemplary central encryption service 104, while FIG. 3b is a flowchart depicting exemplary steps that may be performed by the exemplary central encryption service 104 providing the replacement value to the exemplary client 108 in accordance with an embodiment of the present invention. The exemplary networked system 200 depicts the client 108 requesting secure storage 202 for a social security number (SSN) as a sensitive data value, although it is understood that any type of sensitive data may receive similar treatment using the concepts described herein. (Step 310) The client 108 generates a store secure field request (SSN) 202 which is received by a client process store secure field 240. The client process store secure field 240 sends a request with a plain text format of the SSN (PT-SSN) 204 for secure transport via a secure transport 206, which may transport the information via, for example, a SSL transport to the hardened facility 102. The hardened facility 102 receives the request and then authenticates the requestor, for example, the hardened facility 102 authenticates 208 the client process which sent the data. (Step 320) If the requestor is not authenticated, the hardened facility 102 may respond to the request with an “access denied” response.

If the requester is authenticated, then the central encryption service 104 receives the PT-SSN 212 to process the PT-SSN 212 via a store secure field 214 process. A replacement SSN (R-SSN) 216 is received from a generate replacement key for secure field 218 process. (Step 322) The replacement key value may be generated by a random number generator as a value having the same length and data type as the original actual data value (e.g., numeric, nine digit value for SSN), and may be unique for each actual data value. It is preferable that the replacement key value be unique for each actual data value. One skilled in the art of data processing would recognize that there are many ways to obtain or generate the replacement key values such that they have a relationship with the PT-SSN 212 that is not easily ascertainable to a potential hacker, without departing from the spirit and scope of the present invention. Further, the replacement key values may be generated in advance of the receipt of a request, or they may be generated upon request. The PT-SSN 212 and the R-SSN 222 are then received by encrypt SSN 224, which encrypts the PT-SSN 212 using an encryption technique of choice used by the hardened facility 102, by using long term encryption keys 226 maintained by the hardened facility 102. (Step 324) Advanced Encryption Standard (AES) may be used as an exemplary encryption technique. The encrypted SSN (ESSN) and the replacement SSN, as an ESSN, R-SSN pair 228, are then stored in a secure field storage 230 under the control of the hardened facility 102. (Step 326) The R-SSN is then sent as R-SSN 220 to the secure transport 206 (Step 328) for secure transport to the client process store secure field 240 via a securely transported R-SSN 232, (Step 312) for replacement of the original actual data value, and for storage as R-SSN 234 in a client application storage 236. (Step 314) The R-SSN stored by the client may then be used to request the actual data value from the hardened facility 102 when needed.

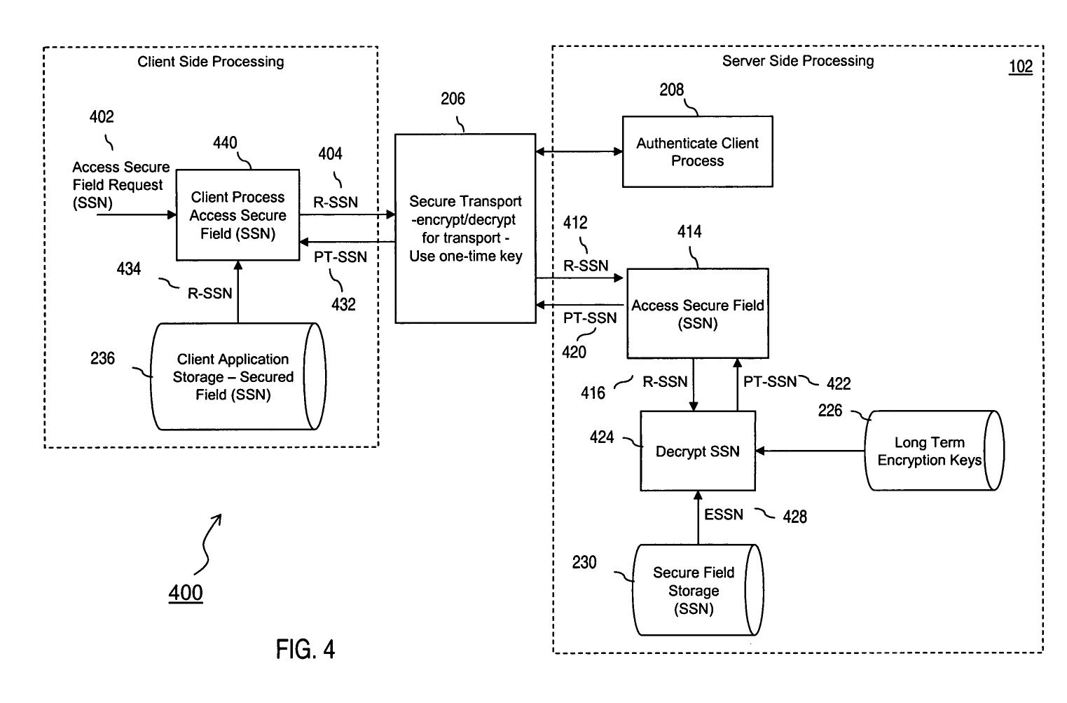

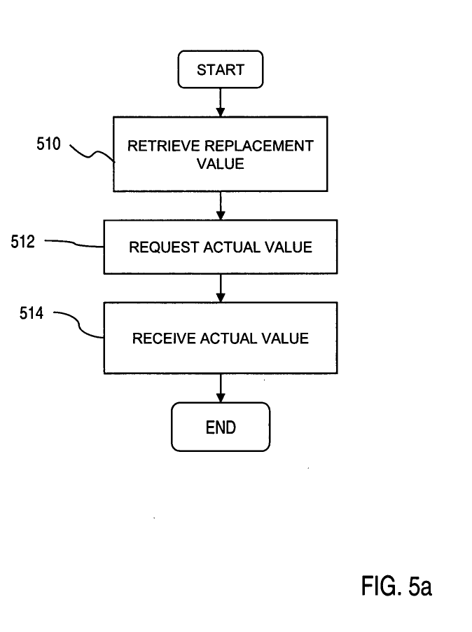

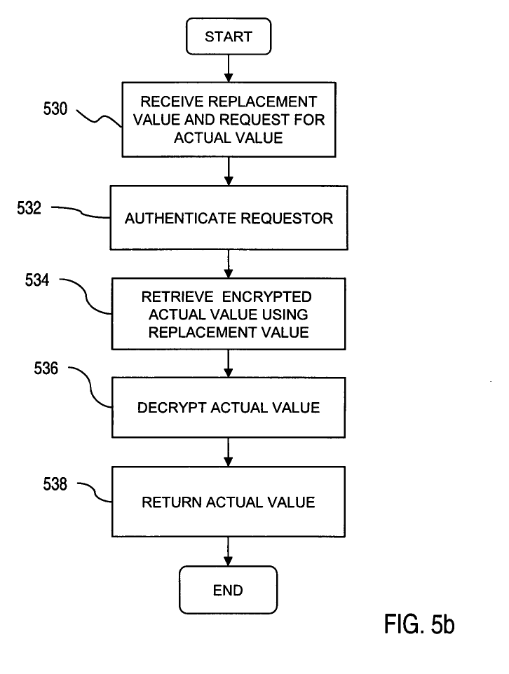

FIG. 4 depicts a networked system with an exemplary central encryption service 104 for retrieving stored actual values for an exemplary client 108. Meanwhile, FIG. 5a is a flowchart depicting exemplary steps that may be performed by the exemplary client 108 requesting an actual value from the exemplary central encryption service 104, and FIG. 5b is a flowchart depicting exemplary steps that may be performed by the exemplary central encryption service 104 providing the requested actual value to the exemplary client 108 according to an exemplary embodiment of the present invention. The exemplary networked system 400 depicts the client 108 requesting access 402 to a securely stored actual data value, for example, a social security number (SSN), although it is understood that any type of sensitive data may receive similar treatment using the concepts described herein. A client process access secure field 440 requests and receives a replacement value, for example, R-SSN 434 from the client application storage 236. (Step 510). The client process access secure field 440 then sends a request for the securely stored actual data value, with a plain text format of the R-SSN 404, for secure transport via the secure transport 206, which may transport the information via, for example, a SSL transport to the hardened facility 102. (Step 512) The hardened facility 102 receives the request (Step 530) and then authenticates the requestor, for example, the hardened facility 102 authenticates 208 the client process which sent the request. (Step 532) If the requestor is not authenticated, the hardened facility 102 may respond to the request with an “access denied” response.

If the requestor is authenticated, then the central encryption service 104 receives the R-SSN 412 to process the plain text R-SSN 412 via an access secure field 414 process. The R-SSN 416 is then received by decrypt SSN 424, which retrieves the ESSN 428, from the secure field storage 230, for example, by using the R-SSN 416 as a look-up value. (Step 534) The decrypt SSN 424 decrypts the ESSN 428 using a decryption technique of choice used by the hardened facility 102, by using long term encryption keys 226 maintained by the hardened facility 102 which were used to encrypt the ESSN. (Step 536) The decrypted actual value of the SSN is then sent as a PT-SSN 422 to the access secure field 414. The access secure field 414 then forwards the PT-SSN 420 to the secure transport 206 (Step 538) for secure transport to the client process access secure field 440 via a securely transported PT-SSN 432, (Step 514) for use by the requestor via client 108.

This technique advantageously avoids any need for the clients 108 to store sensitive data in their own storage facilities, thus relieving the clients from the tasks of determining how to encrypt and store their sensitive data as hackers become more and more sophisticated, and as laws are passed requiring more and more security.

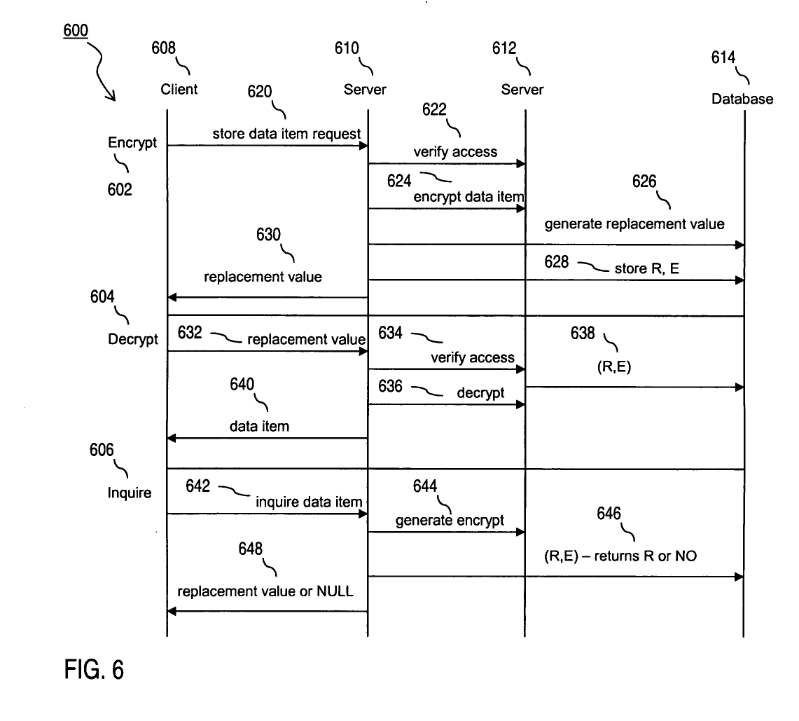

FIG. 6 depicts an exemplary system flow diagram 600 illustrating a data flow between an exemplary client 608 or requestor and an exemplary central encryption service 104 in accordance with an exemplary embodiment of the present invention. The exemplary system flow diagram 600 illustrates flows of data for each of three client application program interfaces (APIs) for encrypt 602, decrypt 604, and inquire 606. Each of these APIs may be supported, for example, by extensible markup language (XML) implementations. Further, a connect API may be used to connect the client application to the security infrastructure to validate roles and access levels of the requestor client 608. A disconnect API may also be utilized to disconnect the client 608.

For the purposes of explanation, the dataflow of the exemplary encrypt API 602 is explained with respect to the system of FIG. 2. In accordance with the exemplary encrypt API 602, the client 608 sends a request 620 to store a data item to a server 610, via the client process store secure field 240, which may send a request with a plain text format of the data item such as the PT-SSN 204. Once a secure connection, for example, an SSL connection via the secure transport 206, is established and a connect API returns success, the encrypt API 602 can be called. In step 622, the server 610 then verifies access rights of the requestor via a server 612, for example, via the authenticate client process 208, and in step 624 requests encryption of the data item, for example, via the encrypt SSN 224. The server 612 receives a generated replacement value 626 for the data item, and in step 628 stores the replacement value and the encrypted data value as a data pair R,E, for example, ESSN, R-SSN 228, in a database 614 such as secure field storage 230, which is under the control of the central encryption service 104. In step 630, the replacement value such as R-SSN 220 is then returned to the client 608 via the secure transport 206 and the client process store secure field 240 for storage in the client's storage media 236. When the client needs the actual value, for example, for viewing, billing or reporting, the decrypt API 604 may be called to retrieve the actual data value from the database 614.

For the purposes of explanation, the dataflow of the exemplary decrypt API 604 and the exemplary inquire API 606 are explained with respect to the system of FIG. 4. In accordance with the exemplary decrypt API 604, the client 608 sends a request 632 to retrieve a data item to the server 610 by sending the replacement value of the data item with the request 632, for example, via the client process access secure field 440, which may send a request with a plain text format of the replacement value associated with the data item such as the R-SSN 404. Once a secure connection, for example, an SSL connection via the secure transport 206, is established and a connect API returns success, the decrypt API 604 can be called. In step 634, the server 610 then verifies access rights of the requestor via the server 612, via the authenticate client process 208, and in step 636 requests decryption of the data item that is associated with the received replacement value such as R-SSN 412, for example, via the decrypt SSN 424. In step 638, the server 612 retrieves the encrypted data value, for example, the ESSN 428 from the database 614 such as the secure field storage 230 using the replacement value, for example, the R-SSN 416 for the data item. The encrypted data value is then decrypted and in step 640 the decrypted value, for example, PT-SSN 420 is then returned to the client 608, via the secure transport 206 and the client access secure field 440, for use by the client 608.

In accordance with the exemplary inquire API 606, the client 606 sends a request 642 to the server 610 to inquire about the existence in the database 614 of a particular data item by sending the value of the data item with the request 642, via a client process which may send a request with a plain text format of the data item such as the PT-SSN 204. In step 644, the server 610, in conjunction with server 612, generates an encrypted version of the data item, for example, via the encrypt SSN 224 and the long term encryption keys 226. Additionally, in step 646, the server 610 searches the database 614 such as the secure field storage 230 for the encrypted data value. The search returns a value of a replacement value for the encrypted data value if the data item is stored in the database 614, or a value indicating that the encrypted value was not found, for example, a value of NULL. In step 648, the replacement value or NULL is then returned to the client 608.

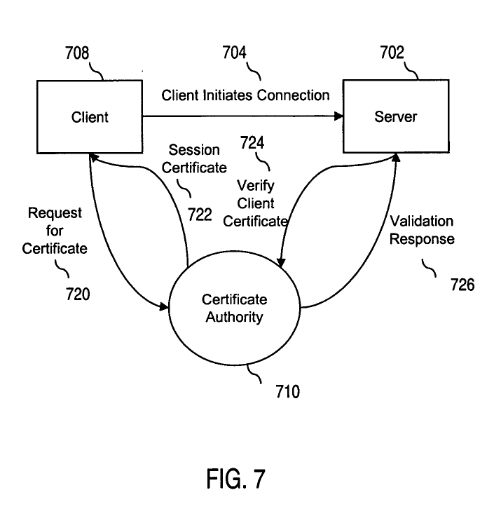

FIG. 7 depicts an exemplary system flow diagram illustrating data flow between an exemplary client 708 and an exemplary server service 702 providing secure communication in accordance with an exemplary embodiment of the present invention. Data transferred between the client 708 and the server service 702 is preferably encrypted for transport, for example, by use of secure transport services such as SSL. It may also utilize server side authentication of client processes with legitimate need to store or retrieve select critical fields (e.g., SSN, driver license number, card numbers, etc). The client may also authenticate the server via certification, for example, to ensure that the client is connected to a valid server.

SSL involves the use of strong encryption of all transmitted data using a combination of publicly held keys to encrypt the data and privately held keys which are used by the receiving system to decrypt the data. These keys are exchanged via a trusted sourced which is known as a certificate server. Through a trusted relationship that is established between the client, server, and the certificate server, the client and server can be assured that each entity is the actual entity indicated by a particular transmission, and that the data stream will maintain a high level of privacy and integrity.

The exemplary technique described herein may, for example, be used to authenticate a requestor of data from the hardened facility 102 as described above, for example, with regard to the authenticate client process 208. A client 708 sends a request for a certificate 720 to a trusted certificate authority 710, which returns a session certificate 722 to the client 708. As the client initiates the connection 704, the underlying mechanics of SSL may obtain a digital certificate in order to successfully establish a communications pipe. This certificate is obtained from a certificate authority site 710, which is a trusted third party server. The digital certificates are electronic files that are used to identify people and resources over networks such as the Internet. Digital certificates also enable secure, confidential communication between two parties using encryption. The certificate performs two functions: 1) it identifies a client (individual or application) as a trusted known entity; and 2) it provides the client with the certificate which will be used to exchange information with the server.

Once the digital certificate is obtained, the SSL protocol uses it to create a secure, confidential communications “pipe” between two entities. Data transmitted over an SSL connection cannot be tampered with or forged without the two parties becoming immediately aware of the tampering. Digital certificates are based on public-key cryptography, which uses a pair of keys for encryption and decryption. With public-key cryptography, keys work in pairs of matched “public” and “private” keys. The public key is used by the client to encrypt the data passed to the server. Only the server knows how to decrypt the message using its private key. When it is time for the server to respond, it uses the client's public key to encrypt the reply. Only the client will be able to decrypt this message using its own privately held key.

The client initiates 704 a connection with the server 702. In order to authenticate the requestor client 708, the server 702 sends a request 724 to verify the client certificate. The trusted certificate authority 710 then sends a validation response 726 to the server 702 after determining the validity of the client request to the server 702. While this discussion focuses on an exemplary use of SSL, one skilled in the art of data processing will understand that any secure transport technique may be used without departing from the spirit and scope of the present invention.

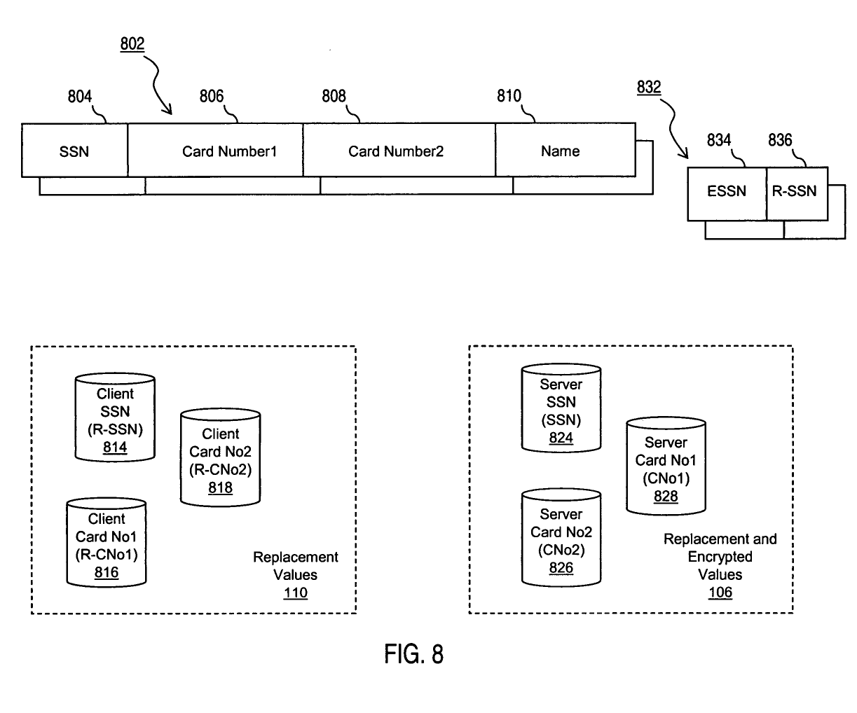

FIG. 8 depicts an exemplary customer record 802 for an exemplary client system. FIG. 8 also depicts an exemplary value pair 832 comprising encrypted value (ESSN) 834 and replacement value (R-SSN) 836 for an exemplary central encryption service. Further, FIG. 8 depicts exemplary storage for replacement values storage 110 for the client system and for encrypted values storage 106 for the exemplary central encryption service in accordance with an exemplary embodiment of the present invention. The value pair 832 depicts, specifically for an exemplary social security number (SSN) field, a logical view of the data managed by the central encryption service. For example, the central encryption service may store an indicator of the association or relationship between the encrypted value 834 and the replacement value 836 in the encrypted values storage 106. The replacement value 836 may be used as an index to store or retrieve the encrypted value 834, or the pair may be stored as a data pair. One skilled in the art will recognize that there are many different ways, additional to those enumerated herein, for storing such an indicator without departing from the spirit or scope of the present invention.

The customer record 802 depicts a logical view of a customer's information including a social security number (SSN) 804, a “card number1” 806, a “card number2” 808, and a customer name 810. The SSN field is typically a nine digit numeric field, and card numbers may be any length and any data type; for example, a calling card number may be ten digits, a credit card number may be sixteen digits, and a driver license number may be any length and include any combination of digits, letters, or other characters.

The actual data from sensitive data fields may be stripped from the logical customer record 802 such that, for example, the actual SSN value 804 may be encrypted and stored in the encrypted values storage 106 for “server SSN” 824 storage for the exemplary central encryption service. Only the replacement value for the SSN value 804 is stored in the replacement values storage 110, in a “client SSN” 814 storage medium on the client side. Similarly, the actual “card number1” value 806 and the “card number2” value 808 may be separately encrypted and stored in respective storage media “server card no1” 828 and “server card no2” 826, with the respective replacement values for these fields stored respectively in “client card no1” storage 816 and “client card no2” storage 818. Information regarding multiple data fields may be sent in one transmission between the clients 108 and the hardened facility 102.

An advantage of separating out the various fields of the logical customer record 802 lies in the difficulty posed to a potential hacker in his/her attempt to decipher meaning out of the data stored in the client's storage media and the data stored in the server's storage media. To one not privy to the exact technique used to produce the replacement values, each of the separate storage media of the client merely contain meaningless strings of data that are only useful in requesting a lookup from the server. Furthermore, the encrypted data stored in the separate storage media 824, 826, and 828 on the server side, while each contains encrypted sensitive data, none of the data is theoretically useful to a hacker, as, for example, a social security number, driver license number, or card number is potentially useless without further information, such as a corresponding name.

An advantage of separating the encryption from the client to the central encryption service 104 is that the clients 108 do not have to worry about keeping up with the technology of encrypted storage or key management. The central encryption service 104 may keep track of its own encryption keys used for encrypting the stored actual data values, and may periodically decrypt and re-encrypt the stored values periodically, for example, as stronger encryption is deemed desirable, with the encryption process completely unknown and invisible to the clients 108. As long as client systems do not store the actual data values in any type of temporary files or other long-term storage, the actual values are very secure. The client systems may communicate replacement values for data fields among other client systems, such that the actual values will only be accessed from the hardened facility when needed.

Further, different data fields may need varying levels of access security. For example, a supervisor may need access to employee numbers of his/her working group, but may not need access to the driver license numbers of those employees, while a human resources administrator may need access to the driver license numbers of the employees. All of these considerations may be included in the client applications and the applications of the central encryption service to enable appropriate access only to those who are entitled.

The system described herein may easily support redundancy, high efficiency, and operational reliability with hardened security. Batch and/or online interfaces may be utilized. The system described herein is easily extended to track use scenarios, for example, use statistics and audits.

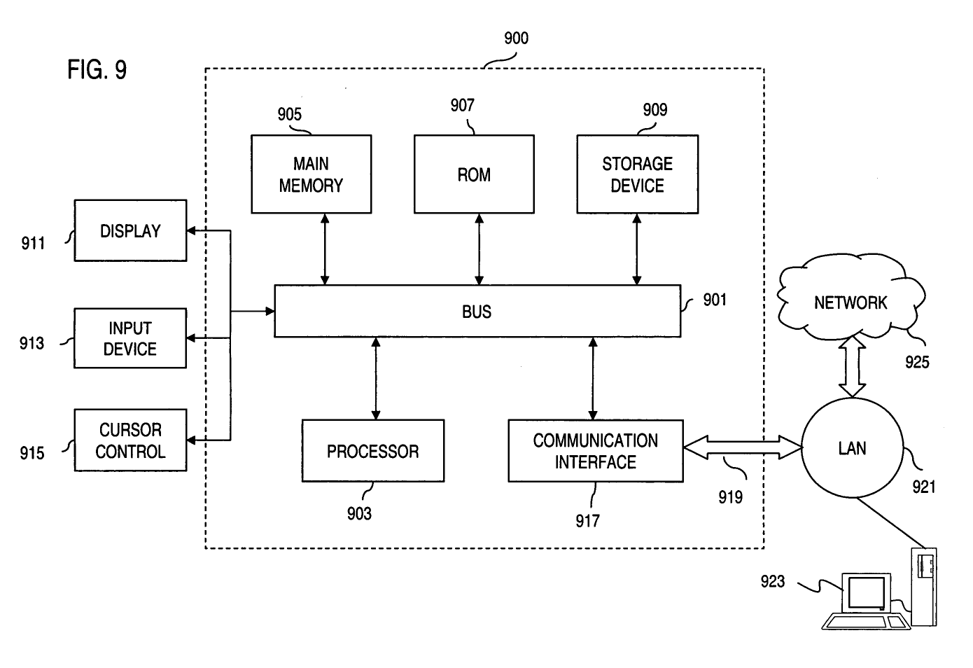

FIG. 9 illustrates a computer system 900 upon which an embodiment according to the present invention can be implemented. The computer system 900 includes a bus 901 or other communication mechanism for communicating information and a processor 903 coupled to the bus 901 for processing information. The computer system 900 also includes main memory 905, such as a random access memory (RAM) or other dynamic storage device, coupled to the bus 901 for storing information and instructions to be executed by the processor 903. Main memory 905 can also be used for storing temporary variables or other intermediate information during execution of instructions by the processor 903. The computer system 900 may further include a read only memory (ROM) 907 or other static storage device coupled to the bus 901 for storing static information and instructions for the processor 903. A storage device 909, such as a magnetic disk or optical disk, is coupled to the bus 901 for persistently storing information and instructions.

The computer system 900 may be coupled via the bus 901 to a display 911, such as a cathode ray tube (CRT), liquid crystal display, active matrix display, or plasma display, for displaying information to a computer user. An input device 913, such as a keyboard including alphanumeric and other keys, is coupled to the bus 901 for communicating information and command selections to the processor 903. Another type of user input device is a cursor control 915, such as a mouse, a trackball, or cursor direction keys, for communicating direction information and command selections to the processor 903 and for controlling cursor movement on the display 911.

According to one embodiment of the invention, central encryption and storage of sensitive data values is provided by the computer system 900 in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multi-processing arrangement may also be employed to execute the instructions contained in main memory 905. In alternative embodiments, hard-wired circuitry may be used in place of or in combination with software instructions to implement the embodiment of the present invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the present invention are not limited to any specific combination of hardware circuitry and/or software.

The computer system 900 also includes a communication interface 917 coupled to bus 901. The communication interface 917 provides a two-way data communication coupling to a network link 919 connected to a local network 921. For example, the communication interface 917 may be a digital subscriber line (DSL) card or modem, an integrated services digital network (ISDN) card, a cable modem, a telephone modem, or any other communication interface to provide a data communication connection to a corresponding type of communication line. As another example, communication interface 917 may be a local area network (LAN) card (e.g. for Ethernet™ or an Asynchronous Transfer Model (ATM) network) to provide a data communication connection to a compatible LAN. Wireless links can also be implemented. In any such implementation, communication interface 917 sends and receives electrical, electromagnetic, or optical signals that carry digital data streams representing various types of information. Further, the communication interface 917 can include peripheral interface devices, such as a Universal Serial Bus (USB) interface, a PCMCIA (Personal Computer Memory Card International Association) interface, etc. Although a single communication interface 917 is depicted in FIG. 9, multiple communication interfaces can also be employed.

The network link 919 typically provides data communication through one or more networks to other data devices. For example, the network link 919 may provide a connection through local network 921 to a host computer 923, which has connectivity to a network 925 (e.g. a wide area network (WAN) or the global packet data communication network now commonly referred to as the “Internet”) or to data equipment operated by a service provider. The local network 921 and the network 925 both use electrical, electromagnetic, or optical signals to convey information and instructions. The signals through the various networks and the signals on the network link 919 and through the communication interface 917, which communicate digital data with the computer system 900, are exemplary forms of carrier waves bearing the information and instructions.

The computer system 900 can send messages and receive data, including program code, through the network(s), the network link 919, and the communication interface 917. In the Internet example, a server (not shown) might transmit requested code belonging to an application program for implementing an embodiment of the present invention through the network 925, the local network 921 and the communication interface 917. The processor 903 may execute the transmitted code while being received and/or store the code in the storage device 909, or other non-volatile storage for later execution. In this manner, the computer system 900 may obtain application code in the form of a carrier wave.

The term “computer-readable medium” as used herein refers to any medium that participates in providing instructions to the processor 905 for execution. Such a medium may take many forms, including but not limited to non-volatile media, volatile media, and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims. The following Appendix A includes a list of acronyms included herein, and is included for ease in reading.

### Appendix A

AES Advanced Encryption Standard

API Application Program Interfaces

ATM Asynchronous Transfer Model

CD-ROM Compact Disk Read Only Memory

CDRW Compact Disk ReWriteable

CRT Cathode Ray Tube

DSL Digital Subscriber Line

DVD Digital Video Disk

EPROM Erasable Programmable Read Only Memory

CNo1 Card Number1

CNo2 Card Number2

ESSN Encrypted Social Security Number

FPGA Field Programmable Gate Arrays

IR Infrared

ISDN Integrated Services Digital Network

LAN Local Area Network

PCMCIA Personal Computer Memory Card International Association

PDA Personal Digital Assistant

PROM Programmable Read Only Memory

PT-SSN Plain Text Format Social Security Number

RAM Random Access Memory

R,E Data Pair: Replacement Data Value and Encrypted Data Value

RF Radio Frequency

ROM Read Only Memory

R-SSN Replacement Social Security Number

SSL Secure Sockets Layer

SSN Social Security Number

USB Universal Serial Bus

WAN Wide Area Network

XML Extensible Markup Language

What is claimed is:

1. A method for securely storing data, the method comprising:
receiving an actual data value from a requestor;
obtaining a replacement value having an association with the actual data value;
encrypting the actual data value;
storing an indicator indicating the association between the encrypted data value and the replacement value; and
transmitting the replacement value to the requestor.

2. A method according to claim 1, further comprising authenticating the requestor.

3. A method according to claim 1, wherein the replacement value includes the same data format as the actual data value.

4. A method according to claim 1, wherein the step of storing the indicator indicating the association between the encrypted data value and the replacement value includes storing the encrypted data value and the replacement value as a pair of data values.

5. A method according to claim 1, wherein the step of receiving the actual data value includes receiving the actual data value from the requestor via a secure connection using a one-time key value.

6. A method for securely managing data, the method comprising:
transmitting an actual data value by a requestor to a hardened facility for storage at the hardened facility;
receiving a replacement value associated with the actual data value; and
storing the replacement value by the requester.

7. A method according to claim 6, further comprising:
transmitting the replacement value to the hardened facility; and
receiving the actual data value from the hardened facility.

8. A method according to claim 6, wherein the step of transmitting the actual data value includes transmitting the actual data value by the requestor to the hardened facility for storage at the hardened facility via a secure connection using a one-time key value.

9. A method comprising:
transmitting a first actual data value corresponding to a first sensitive data field value and a second actual data value corresponding to a second sensitive data field value included in a plurality of records of a requestor from the requestor to a hardened facility for storage at the hardened facility;
receiving a first replacement value associated with the first actual data value and a second replacement value associated with the second actual data value; and
storing the first replacement value in a first storage device and the second replacement value in a second storage device by the requestor.

10. A method according to claim 9, further comprising:
transmitting the first replacement value to the hardened facility; and
receiving the first actual data value from the hardened facility.

11. A central encryption system for securely managing data, the system comprising:
a central encryption device configured to receive an actual data value from a requester, to obtain a replacement value associated with the actual data value, to encrypt the actual data value, to store an indicator of an association between the replacement value and the encrypted data value, and to transmit the replacement value to the requestor; and
a storage device for storing the indicator of the association between the replacement value and the encrypted data value.

12. A central encryption system for securely managing data, the system comprising:
a central encryption device configured to receive a replacement value associated with an actual data value from a requester, to retrieve an encrypted data value corresponding to the actual data value based on the replacement value, to decrypt the encrypted data value to obtain the actual data value, and to transmit the actual data value to the requestor; and
a storage device for storing the replacement value and the encrypted data value.

13. A central encryption and storage system comprising:
means for receiving an actual data value from a requester;
means for obtaining a replacement value associated with the actual data value;
means for encrypting the actual data value;
means for storing the encrypted data value; and
means for transmitting the replacement value to the requestor.

14. A central encryption and storage system according to claim 13, further comprising:
means for receiving an other replacement value associated with an other actual data value from the requestor;
means for retrieving an other encrypted data value corresponding to the other actual data value based on the other replacement value;
means for decrypting the other encrypted data value to obtain the other actual data value; and
means for transmitting the other actual data value to the requestor.

15. A central encryption and storage system according to claim 13, further comprising means for authenticating the requestor.

16. A secure system comprising:
a first process configured to transmit an actual data value from the secure system to a central manager for storage by the central manager and to receive a replacement value associated with the actual data value; and
a storage device configured to store the replacement value.

17. A system according to claim 16, further comprising:
a second process configured to transmit the replacement value to the central manager and to receive the actual data value from the central manager.

18. A system according to claim 16, wherein the first process is further configured to transmit the actual data value from the secure system to the central manager for storage by the central manager via a secure connection using a one-time key value.

19. A system according to claim 18, wherein the secure connection is via a secure sockets layer (SSL) connection.

20. A system according to claim 17, wherein the first and second processes include extensible markup language (XML) instructions.
